(19) United States
(12) Patent Application Publication
(10) Pub. No.: US 2026/0156567 A1
(43) Pub. Date: Jun. 4, 2026

(54) HANDLING OF SIB1 VALIDITY

(71) Applicant: Nokia Technologies Oy, Espoo (FI)

(72) Inventors: Srinivasan SELVAGANAPATHY, Bangalore (IN); Tero HENTTONEN, Espoo (FI); Daniela LASELVA, Aalborg (DK); Yan Ji ZHANG, Beijing (CN)

(21) Appl. No.: 19/360,237

(22) Filed: Oct. 16, 2025

(30) Foreign Application Priority Data
Nov. 27, 2024 (WO) PCT/CN2024/134892

(51) Int. Cl. H04W 52/02; H04W 48/16

(52) U.S. Cl. CPC H04W 52/0203; H04W 48/16

(57) ABSTRACT

Example embodiments of the present disclosure relate to a terminal device, a method, apparatus, a computer readable storage medium and a computer program product for a validity of stored SIB1. In the solution, the terminal device may store SIB1 associated with a first network device, which comprises first information related to a first value tag. The terminal device may receive system information comprising second information related to a second value tag. In addition, the terminal device may determine a validity of the stored SIB1 based on the first information related to the first value tag and second information related to the second value tag. As such, the validity of the stored SIB1 can be determined and accordingly the SIB1 acquisition procedure is not required if the stored SIB1 is valid, therefore, the signalling overhead can be reduced.

### FIELD

Example embodiments of the present disclosure generally relate to the field of communications and in particular, to a terminal device, a method, apparatus, a computer readable storage medium and a computer program product for handling of a system information block 1 (SIB1) validity.

### BACKGROUND

One of the objectives for release 19 (Rel-19 or R19) of the fifth generation (5G) new radio (NR) network energy saving (NES) functionality is to enable on-demand (OD) SIB1 cell operation for radio resource control (RRC) idle/inactive/connected e.g. depending on the cell loading. User equipment (UE) can request for SIB1 scheduling on-demand by sending a request, for example a wake-up signal (WUS) for this purpose. For example, the wake-up signal may be a physical random access channel (PRACH) preamble. Such feature removes the need to transmit the SIB1 regularly and provides significant network energy saving gain, the higher gain the lower is the rate of SIB1 requests.

### SUMMARY

In general, example embodiments of the present disclosure provide a solution for handling of SIB1 validity.

In a first aspect, there is provided a terminal device. The terminal device comprises: at least one processor; and at least one memory storing instructions, wherein the instructions when executed by the at least one processor, cause the terminal device at least to: store a SIB1 associated with a first network device, wherein the stored SIB1 comprises first information related to a first value tag; based on a trigger to acquire or reacquire from the first network device system information (SI) that comprises second information related to a second value tag, determine that the stored SIB1 is valid for the first network device based on the first information related to the first value tag and the second information related to the second value tag; and based on determining that the stored SIB1 is valid for the first network device, determine that a SIB1 acquisition procedure is not required.

In a second aspect, there is provided a terminal device. The terminal device comprises: at least one processor; and at least one memory storing instructions, wherein the instructions when executed by the at least one processor, cause the terminal device at least to: store a SIB1 associated with a first network device, wherein the stored SIB1 comprises first information related to a first value tag, a first part of the first value tag is related to an access information part of the stored SIB1 and a second part of the first value tag is related to a camping information part of the stored SIB1; based on a trigger to acquire or reacquire from the first network device system information, determine whether the access information part or the camping information part of the stored SIB1 is valid for the first network device at least based on corresponding parts of the first value tag; and based on determining that at least one of the access information part or the camping information part of the stored SIB1 is invalid for the first network device, perform a SIB1 acquisition procedure for at least one of the access information part or the camping information part of the SIB1.

In a third aspect, there is provided a method. The method comprises: storing a SIB1 associated with a first network device, wherein the stored SIB1 comprises first information related to a first value tag; based on a trigger to acquire or reacquire from the first network device system information that comprises second information related to a second value tag, determining that the stored SIB1 is valid for the first network device based on the first information related to the first value tag and the second information related to the second value tag; and based on determining that the stored SIB1 is valid for the first network device, determining that a SIB1 acquisition procedure is not required.

In a fourth aspect, there is provided a method. The method comprises: storing a SIB1 associated with a first network device, wherein the stored SIB1 comprises first information related to a first value tag, a first part of the first value tag is related to an access information part of the stored SIB1 and a second part of the first value tag is related to a camping information part of the stored SIB1; based on a trigger to acquire or reacquire from the first network device system information, determining whether the access information part or the camping information part of the stored SIB1 is valid for the first network device at least based on corresponding parts of the first value tag; and based on determining that at least one of the access information part or the camping information part of the stored SIB1 is invalid for the first network device, performing a SIB1 acquisition procedure for at least one of the access information part or the camping information part of the SIB1.

In a fifth aspect, there is provided an apparatus. The apparatus comprises: means for storing a SIB1 associated with a first network device, wherein the stored SIB1 comprises first information related to a first value tag; means for based on a trigger to acquire or reacquire from the first network device system information that comprises second information related to a second value tag, determining that the stored SIB1 is valid for the first network device based on the first information related to the first value tag and the second information related to the second value tag; and means for based on determining that the stored SIB1 is valid for the first network device, determining that a SIB1 acquisition procedure is not required.

In a sixth aspect, there is provided an apparatus. The apparatus comprises: means for storing a SIB1 associated with a first network device, wherein the stored SIB1 comprises first information related to a first value tag, a first part of the first value tag is related to an access information part of the stored SIB1 and a second part of the first value tag is related to a camping information part of the stored SIB1; means for based on a trigger to acquire or reacquire from the first network device system information, determining whether the access information part or the camping information part of the stored SIB1 is valid for the first network device at least based on corresponding parts of the first value tag; and means for based on determining that at least one of the access information part or the camping information part of the stored SIB1 is invalid for the first network device, performing a SIB1 acquisition procedure for at least one of the access information part or the camping information part of the SIB1.

In a seventh aspect, there is an apparatus. The apparatus comprises: storing circuitry configured to store a SIB1 associated with a first network device, wherein the stored SIB1 comprises first information related to a first value tag; determining circuitry configured to based on a trigger to acquire or reacquire from the first network device system information that comprises second information related to a second value tag, determine that the stored SIB1 is valid for the first network device based on the first information related to the first value tag and the second information related to the second value tag; and determining circuitry configured to based on determining that the stored SIB1 is valid for the first network device, determine that a SIB1 acquisition procedure is not required.

In an eighth aspect, there is an apparatus. The apparatus comprises: storing circuitry configured to store a SIB1 associated with a first network device, wherein the stored SIB1 comprises first information related to a first value tag, a first part of the first value tag is related to an access information part of the stored SIB1 and a second part of the first value tag is related to a camping information part of the stored SIB1; determining circuitry configured to based on a trigger to acquire or reacquire from the first network device system information, determine whether the access information part or the camping information part of the stored SIB1 is valid for the first network device at least based on corresponding parts of the first value tag; and performing circuitry configured to based on determining that at least one of the access information part or the camping information part of the stored SIB1 is invalid for the first network device, perform a SIB1 acquisition procedure for at least one of the access information part or the camping information part of the SIB1.

In a ninth aspect, there is provided a non-transitory computer readable medium comprising program instructions for causing an apparatus to perform at least the method in a third or fourth aspect.

In a tenth aspect, there is provided a computer program comprising instructions, which, when executed by an apparatus, cause the apparatus to perform at least the method in a third or fourth aspect.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, in which:

FIG. 1A illustrates an example schematic for option 1 of non-standalone mode;

FIG. 1B illustrates an example schematic for option 2 of non-standalone mode;

FIG. 1C illustrates an example schematic for standalone mode;

FIG. 1D illustrates an example of a network environment in which some example embodiments of the present disclosure may be implemented;

FIG. 2A illustrates an example process of an SIB acquisition procedure in accordance with some example embodiments of the present disclosure;

FIG. 2B illustrates another example process of an SIB acquisition procedure in accordance with some example embodiments of the present disclosure;

FIG. 2C illustrates another example process of an SIB acquisition procedure in accordance with some example embodiments of the present disclosure;

FIG. 3 illustrates an example of a process flow for checking a validity of stored SIB1 in accordance with some example embodiments of the present disclosure;

FIG. 4 illustrates another example of a process flow for checking a validity of stored SIB1 in accordance with some example embodiments of the present disclosure;

FIG. 5A illustrates an example of a process flow for receiving value tag in accordance with some example embodiments of the present disclosure;

FIG. 5B illustrates an example process for checking a validity of stored OD-SIB1 in accordance with some example embodiments of the present disclosure;

FIG. 6 illustrates a flowchart of a method implemented at a terminal device in accordance with some example embodiments of the present disclosure;

FIG. 7 illustrates a flowchart of a method implemented at a terminal device in accordance with some example embodiments of the present disclosure;

FIG. 8 illustrates a simplified block diagram of a device that is suitable for implementing some example embodiments of the present disclosure; and

FIG. 9 illustrates a block diagram of an example of a computer readable medium in accordance with some example embodiments of the present disclosure.

Throughout the drawings, the same or similar reference numerals represent the same or similar elements, unless otherwise indicated.

### DETAILED DESCRIPTION

Principles of the present disclosure will now be described with reference to some example embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof. As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

As used in this application, the term “circuitry” may refer to one or more or all of the following:
(a) hardware-only circuit implementations (such as implementations in only analog and/or digital circuitry);
(b) combinations of hardware circuits and software, such as (as applicable):
   (i) a combination of analog and/or digital hardware circuit(s) with software/firmware, and
   (ii) any portions of hardware processor(s) with software (including digital signal processor(s)), software, and memory(ies) that work together to cause an apparatus, such as a mobile phone or server, to perform various functions; and
(c) hardware circuit(s) and/or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as Long Term Evolution (LTE), LTE-Advanced (LTE-A), New Radio (NR), Wideband Code Division Multiple Access (WCDMA), High-Speed Packet Access (HSPA), Narrow Band Internet of Things (NB-IoT), Non-terrestrial network (NTN), IoT over NTN, Wi-Fi and so on. Furthermore, the communications in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G), the sixth generation (6G) communication protocols, IEEE 802.11 protocols and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), a new radio (NR) NB (also referred to as a gNB), a Remote Radio Unit (RRU), a radio header (RH), a remote radio head (RRH), an integrated access and backhaul (IAB) node, a relay, a low power node such as a femto, a pico, and so forth, depending on the applied terminology and technology.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), an Access Terminal (AT), or an internet of things (IoT) device. The terminal device may include, but not limited to, a mobile phone, a cellular phone, a smart phone, voice over IP (VoIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a machine type communication (MTC) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. In the following description, the terms “terminal device”, “communication device”, “terminal”, “user equipment” and “UE” may be used interchangeably.

In the present disclosure, a term “anchor cell” may be used interchangeably with a coverage cell, a coverage layer cell, Cell A, etc., a term “NES cell” may be used interchangeably with a capacity cell, a non-anchor cell, etc. In the present disclosure, the terminal device may be a NES capable UE in some cases. In the present disclosure, a term “WUS configuration” may be used interchangeably with an SIB1 request configuration, a configuration for SIB request, or the like.

On-demand SIB1 operation for UEs in idle/inactive mode or connected mode is being defined in 5G NR with the support of an anchor cell, as part of the ongoing Rel-19 work item description (WID). The intention is that a capacity cell does not broadcast the SIB1 periodically. Instead, the capacity cell (or an associated coverage cell on its behalf) provides the SIB1 on-demand, i.e., based on the UE requesting the transmission of SIB1. The UE triggers the transmission by sending a wake-up signal, which may be a PRACH preamble. In order for the UE to transmit the SIB1 request, the UE first needs to acquire the ‘SIB1 request’ configuration so that the UE knows which resource(s) the UE can use to transmit the SIB1 request. However, when there is no SIB1 available from the capacity cell, the cell itself is unable to provide the ‘SIB1 request’ configuration.

SIB1 is the first information the UE reads in a cell currently, e.g., after the master information block (MIB), and SIB1 defines how all other SIBs can be acquired. The MIB of the capacity cell may be unable to provide the necessary information currently. This means that the capacity cell to operate in on-demand SIB1 mode requires that another cell (e.g., a coverage cell) provides the configuration on its behalf—in its SIB1 or in another of its SIBs. In other words, the single NES cell cannot operate in on-demand SIB1 mode in 5G but requires a two-carrier scenario involving the capacity cell (referred to as an NES cell) and a coverage cell (referred to as an anchor cell or Cell A). In some other cases, however, the MIB content can be different, and therefore OD-SIB1 operation without an anchor cell becomes feasible and attractive.

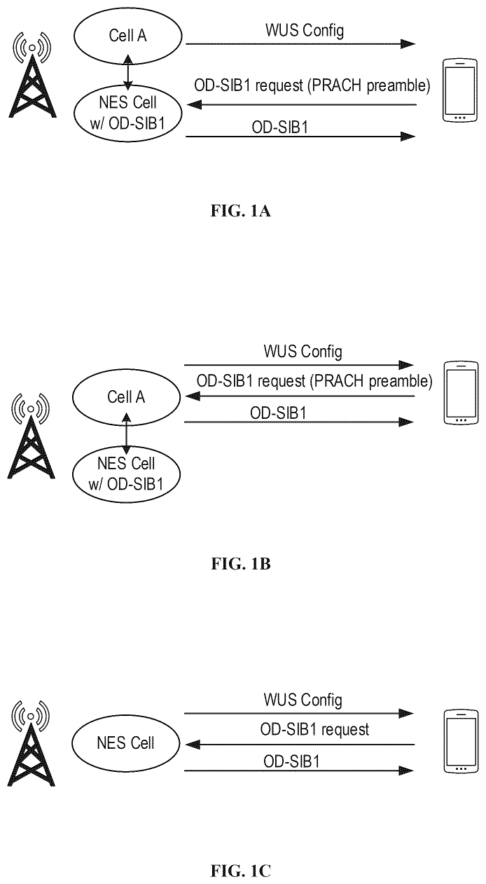

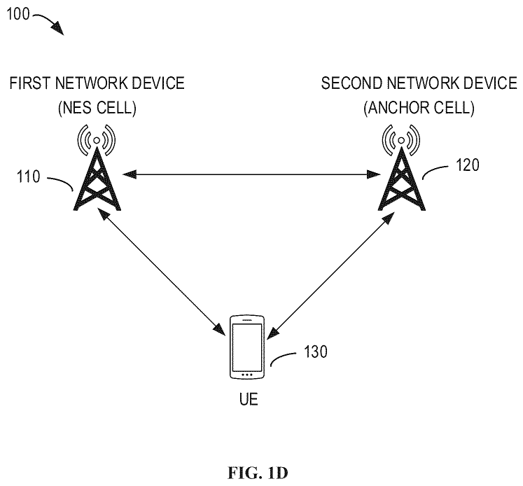

The OD-SIB1 operations should be supported with and without the need for an anchor cell. There can be two operational modes for on-demand SIB1 feature:
Non-standalone mode, i.e., with the support of an anchor cell, as shown in FIGS. 1A-1B; and
Standalone mode, i.e., without the support of an anchor cell, as shown in FIG. 1C.

FIG. 1A illustrates an example schematic for option 1 of non-standalone mode, and FIG. 1B illustrates an example schematic for option 2 of non-standalone mode. In the non-standalone mode, a coverage cell can indicate the on-demand SSB/SIB1 operation in neighboring cells and indicate the wake-up signal configuration that can be used to request the transmission of SSB and/or SIB1 on-demand, e.g., for requesting denser SSB/SIB1.

FIG. 1C illustrates an example schematic for standalone mode. In the standalone mode, the UE can be provisioned with the wake-up signal configuration directly via the NES cell if the cell supports on-demand SIB1.

For the on-demand SIB1 operation in either standalone or non-standalone mode, the UE needs to be able to determine whether the content of the stored SIB1 or the content of the WUS configuration is still valid (and thus can be used) or if there is a change in the SIB1 content that the UE has acquired earlier for the cell. In this regard, an effective solution for validating SIB1 for a NES cell is desired.

Embodiments of the present disclosure provide a solution for a validity of stored SIB1 associated with a NES cell. In the standalone mode, the provided solution can also be applicable for a validity of stored SIB1 associated with a coverage cell. In the solution, the terminal device may store SIB1 associated with a first network device, and the stored SIB1 comprises first information related to a first value tag. The terminal device may receive system information comprising second information related to a second value tag. In addition, the terminal device may determine a validity of the stored SIB1 based on the first information related to the first value tag and second information related to the second value tag. As such, the validity of the stored SIB1 can be determined and accordingly the SIB1 acquisition procedure is not required if the stored SIB1 is valid, therefore, the signalling overhead and energy consumption can be reduced. Principles and implementations of the present disclosure will be described in detail below with reference to the figures.

FIG. 1D illustrates an example of a network environment 100 in which some example embodiments of the present disclosure may be implemented. The network environment 100 may also be called as a network system, a communication environment, a communication network, a communication system, or the like, the present disclosure does not limit this aspect.

The environment 100, which may be a part of a communication network, comprises a first network device 110, a second network device 120, and a terminal device 130. The communication environment 100 may comprise any suitable number of devices and cells.

In the communication environment 100, the first network device 110 may provide services to the terminal device 130, for example, a NES cell may be provided. The first network device 110 is associated with the NES cell. In some cases, the first network device 110 and the terminal device 130 may communicate data and control information with each other. In some embodiments, the first network device 110 and the terminal device 130 may communicate with direct links/channels.

In the communication environment 100, the second network device 120 may provide services to the terminal device 130, for example, an anchor cell may be provided. The second network device 120 is associated with the anchor cell. In some cases, the second network device 120 and the terminal device 130 may communicate data and control information with each other. In some embodiments, the second network device 120 and the terminal device 130 may communicate with direct links/channels.

Communications in the network environment 100 may be implemented according to any proper communication protocol(s), comprising, but not limited to, cellular communication protocols of the first generation (1G), the second generation (2G), the third generation (3G), the fourth generation (4G), the fifth generation (5G) and the sixth generation (6G) and on the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future.

It is to be understood that the numbers of devices and their connection relationships and types shown in FIG. 1D are only for the purpose of illustration without suggesting any limitation. For example, the environment 100 may include any suitable numbers of devices adapted for implementing embodiments of the present disclosure.

It is to be understood that the environment in FIG. 1D is only for illustration without any limitation. For example, the first network device 110 and the second network device 120 may be on different carriers, and a two-carrier scenario may be applied. For example, the second network device 120 may not be needed in some cases, e.g., when a standalone mode in FIG. 1C is applied. For example, while FIG. 1D depicts the terminal device 130 as a mobile phone, the terminal device 130 may be any type of user equipment.

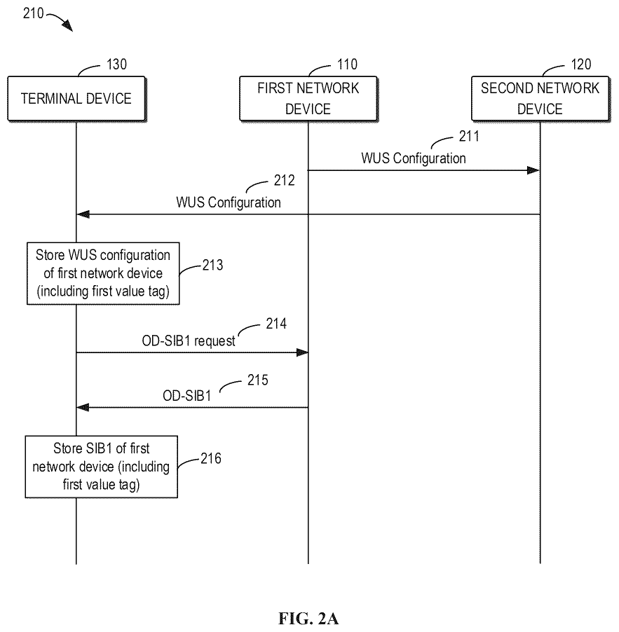

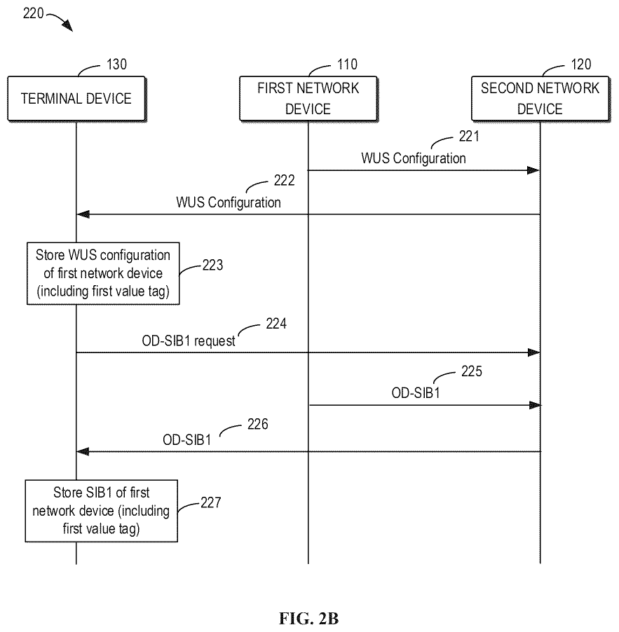

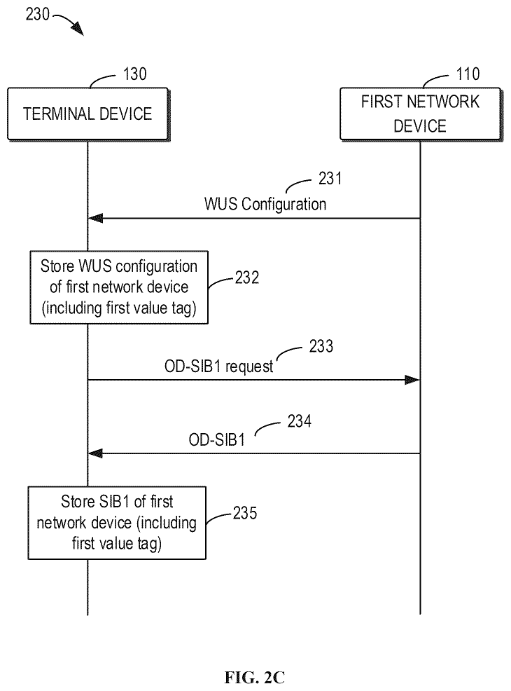

FIG. 2A illustrates an examples of a process flow 210 for SIB acquisition procedure of option 1 of non-standalone mode in accordance with some example embodiments of the present disclosure. For the purpose of discussion, the process flow 210 will be described with reference to FIG. 1D. The process flow 210 involves a first network device 110, a second network device 120, and a terminal device 130. With reference to FIG. 1A, the first network device 110 may be associated with the NES cell, and the second network device 120 may be associated with the Cell A.

In the process flow 210, the second network device 120 receives a WUS configuration from the first network device 110 at 211. In some examples, a value tag (which may be referred to as ValueTag1 for ease of discussion) may be provided together with the WUS configuration associated with the first network device 110. In some examples, the first network device 110 may transmit WUS information (e.g., OD-WUS information) to the second network device 120, where the WUS information includes the WUS configuration and the value tag (i.e., ValueTag1).

The second network device 120 transmits, and the terminal device 130 receives, the WUS configuration at 212. In some examples, the WUS configuration and the value tag (i.e., ValueTag1) may be provided to the terminal device 130. In some examples, an identifier of the first network device 110 may also be provided to the terminal device 130, so that the terminal device 130 may know that the WUS configuration is associated with the first network device 110.

In addition, the terminal device 130 stores the received WUS configuration of the first network device 110 at 213. For example, the stored WUS configuration has the value tag (i.e., ValueTag1).

In the process flow 210, the terminal device 130 transmits, and the first network device 110 receives, an OD-SIB1 request at 214. In some examples, the terminal device 130 may transmit the request based on the WUS configuration. In one example, the terminal device 130 is allowed to use the WUS configuration based on the value tag (i.e. ValueTag1).

The first network device 110 transmits, and the terminal device 130 receives, the OD-SIB1 at 215. In some examples, the first network device 110 may transmit the OD-SIB1 based on the request. In some examples, the OD-SIB1 has a value tag, which may be a first value tag. For example, the first value tag may be the same as ValueTag1 mentioned above for the WUS configuration.

In addition, the terminal device 130 stores the received OD-SIB1 of the first network device 110 at 216. For example, the stored SIB1 has the first value tag (e.g., ValueTag1). In some examples, the stored SIB1 includes first information related to the first value tag.

FIG. 2B illustrates an examples of a process flow 220 for SIB acquisition procedure of option 2 of non-standalone mode in accordance with some example embodiments of the present disclosure. For the purpose of discussion, the process flow 220 will be described with reference to FIG. 1D. The process flow 220 involves a first network device 110, a second network device 120, and a terminal device 130. With reference to FIG. 1B, the first network device 110 may be associated with the NES cell, and the second network device 120 may be associated with the Cell A.

In the process flow 220, the second network device 120 receives a WUS configuration from the first network device 110 at 221. In some examples, a value tag (which may be referred to as ValueTag1 for ease of discussion) may be provided together with the WUS configuration associated with the first network device 110. In some examples, the first network device 110 may transmit WUS information (e.g., OD-WUS information) to the second network device 120, where the WUS information includes the WUS configuration and the value tag (i.e., ValueTag1).

The second network device 120 transmits, and the terminal device 130 receives, the WUS configuration at 222. In some examples, the WUS configuration and the value tag (i.e., ValueTag1) may be provided to the terminal device 130. In some examples, an identifier of the first network device 110 may also be provided to the terminal device 130, so that the terminal device 130 may know that the WUS configuration is associated with the first network device 110.

In addition, the terminal device 130 stores the received WUS configuration of the first network device 110 at 223. For example, the stored WUS configuration has the value tag (i.e., ValueTag1).

In the process flow 220, the terminal device 130 transmits, and the second network device 120 receives, an OD-SIB1 request for the first network device 110 at 224. In some examples, the terminal device 130 may transmit the request based on the WUS configuration.

The second network device 120 may obtain the OD-SIB1 of the first network device 110 from the first network device 110 at 225. In some examples, the OD-SIB1 has a value tag, which may be the first value tag. For example, the first value tag may be the same as ValueTag1 mentioned above for the WUS configuration.

The second network device 120 transmits, and the terminal device 130 receives, the OD-SIB1 of the first network device 110 at 226. In some examples, the second network device 130 may transmit the OD-SIB1 based on the OD-SIB1 request.

In addition, the terminal device 130 stores the received OD-SIB1 of the first network device 110 at 227. For example, the stored SIB1 has the first value tag (e.g., ValueTag1). In some examples, the stored SIB1 includes first information related to the first value tag.

FIG. 2C illustrates an examples of a process flow 230 for SIB acquisition procedure of a standalone mode in accordance with some example embodiments of the present disclosure. For the purpose of discussion, the process flow 230 will be described with reference to FIG. 1D. The process flow 230 involves a first network device 110 and a terminal device 130. With reference to FIG. 1C, the first network device 110 may be associated with the NES cell.

In the process flow 230, the first network device 110 transmits, and the terminal device 130 receives, the WUS configuration at 231. In some examples, the WUS configuration has a value tag (which may be referred to as ValueTag1 for ease of discussion).

In addition, the terminal device 130 stores the received WUS configuration of the first network device 110 at 232. For example, the stored WUS configuration has the value tag (i.e., ValueTag1).

In the process flow 230, the terminal device 130 transmits, and the first network device 110 receives, an OD-SIB1 request at 233. In some examples, the terminal device 130 may transmit the request based on the WUS configuration.

The first network device 110 transmits, and the terminal device 130 receives, the OD-SIB1 at 234. In some examples, the first network device 110 may transmit the OD-SIB1 based on the request. In some examples, the OD-SIB1 has a value tag, which may be the first value tag. For example, the first value tag may be the same as ValueTag1 mentioned above for the WUS configuration.

In addition, the terminal device 130 stores the received OD-SIB1 of the first network device 110 at 235. For example, the stored SIB1 has the first value tag (e.g., ValueTag1). In some examples, the stored SIB1 includes first information related to the first value tag.

According to embodiments with reference to any of FIGS. 2A-2C, the terminal device 130 may store SIB1 associated with the first network device 110, and the stored SIB1 may include first information related to a first value tag. In some examples, the first value tag may indicate a version of the stored SIB1.

In some embodiments, the first value tag may include a first part and a second part, and the first part of the first value tag may be related to an access information part of the stored SIB1, the second part of the first value tag may be related to a camping information part of the stored SIB1. For example, the first part of the first value tag may be referred to as a first sub tag and the second part of the first value tag may be referred to as a second sub tag.

It should be noted that although the process flows in FIGS. 2A-2C are related to OD-SIB1 acquisition, these are only for illustration without any limitation, a SIB1 acquisition other than the OD-SIB1 acquisition is also applied in the present disclosure.

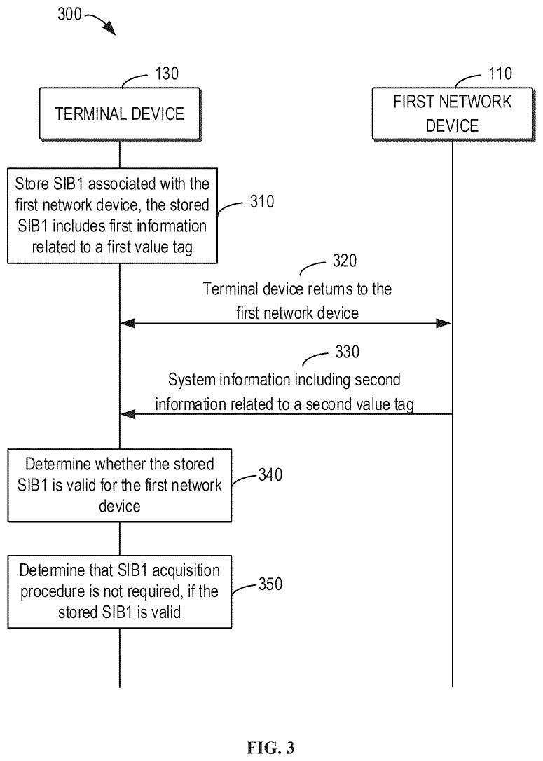

Reference now is made to FIG. 3, which illustrates an example of a process flow 300 in accordance with some example embodiments of the present disclosure. For the purpose of discussion, the process flow 300 will be described with reference to FIG. 1D. The process flow 300 involves a first network device 110 and a terminal device 130. It would be appreciated that although the process flow 300 has been described in the network environment 100 of FIG. 1D, this process flow may be likewise applied to other communication scenarios.

In the process flow 300, the terminal device 130 stores a SIB1 associated with the first network device 110 at 310. In some embodiments, the SIB1 may be acquired based on any process flow in FIGS. 2A-2C, or may be acquired based on a different process flow, and the present disclosure does not limit for this aspect. In some implementations, the SIB1 associated with the first network device 110 is stored upon the terminal device 130 selects or reselects or hands over to a different network device (such as the second network device 120) from the first network device 110. In some embodiments, the stored SIB1 includes first information related to a first value tag.

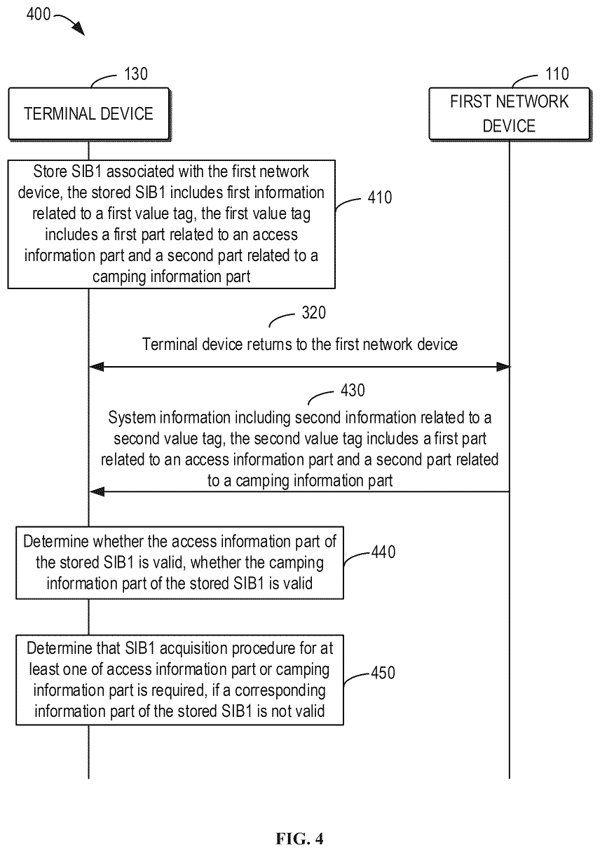

In some embodiments, as illustrated at step 410 in FIG. 4, the first value tag may include a first part and a second part, and the first part of the first value tag may be related to an access information part of the stored SIB1, the second part of the first value tag may be related to a camping information part of the stored SIB1. For example, the first part of the first value tag may be referred to as a first sub tag and the second part of the first value tag may be referred to as a second sub tag.

For example, an information element (IE) “ValueTag-SIB1” or “ValueTag-SIB1-Seg” may be defined for different examples.

| ValueTag-SIB1 ::= CHOICE { | |
|---|---|
| valueTag-full | INTEGER (0 ... 31), |
| valueTag-Seg | ValueTag-SIB1-Seg |
| } | |
| ValueTag-SIB1-Seg ::= SEQUENCE { | |
| valueTag-SIB1-access | INTEGER (0 ... 31), |
| valueTag-SIB1-SIScheduling | INTEGER (0 ... 31) |

}

In the process flow 300, the terminal device 130 returns to the first network device 110 at 320. In some embodiments, the terminal device 130 may return back to the first network device 110 based on any one of the following: upon cell-selection (e.g. upon power on), cell-reselection, returning from out of coverage, after reconfiguration with sync completion, after entering the network from another RAT, upon receiving a request (e.g., a positioning request) from an upper layer, due to an handover from another cell, or the like. For example, the terminal device 130 may hand over from another network device to the first network device 110 in RRC_Connected mode. For example, the terminal device 130 may access or select the first network device 110 after power on. In one example, the trigger is an explicit indication from the network device of SIB1/System Information change or need to re-acquire the SIB1.

In the process flow 300, the terminal device 130 receives system information from the first network device 110 at 330, e.g., based on a trigger to acquire or reacquire the system information. In some examples, the trigger may include at least one of: connecting or reconnecting to the first network device 110, selecting or reselecting the first network device 110, or returning to the first network device 110.

In some examples, the system information includes second information related to a second value tag. In some examples, the second information related to the second value tag may be used for determining whether the stored SIB1 associated with the first network device 110 is still valid. In some examples, the second value tag may indicate a version of SIB1 associated with the returned first network device 110.

In some embodiments, as illustrated at step 430 in FIG. 4, the second value tag may include a first part and a second part, and the first part of the second value tag may be related to an access information part of SIB1, the second part of the second value tag may be related to a camping information part of SIB1. For example, the first part of the second value tag may be referred to as a third sub tag and the second part of the second value tag may be referred to as a fourth sub tag. For example, the second value tag may be related to SIB1 that used for the returned first network device 110.

In some implementations, while returning back to the first network device 110, the terminal device 130 may receive MIB or a physical broadcast channel (PBCH).

In some embodiments, the system information may be the MIB or PBCH, that is, the MIB or the PBCH includes the second information related to the second value tag.

In some embodiments, the system information may be part of information that included in SIB1. In some examples, the system information may be received, after the MIB or PBCH, by the terminal device 130. In some examples, the MIB or PBCH may include an indication of the system information. For example, after receiving the MIB or PBCH, the terminal device 130 may further receive the system information based on the indication, and the received system information includes the second information related to the second value tag. For example, the indication in MIB or PBCH may indicate that the system information will be transmitted after the MIB or PBCH. For example, the indication in MIB or PBCH may be a pointer to system information.

In embodiments that the system information is part of information that may be included in SIB1, the system information may be called as a mini-SIB1, a mini-SIB, a short SIB1, or the like, which may not need include all information that in SIB1. For a specific example, the system information includes only the second information related to the second value tag. For another specific example, the SIB1 does not include the system information, which is included in the mini-SIB1.

In the process flow 300, the terminal device 130 determines whether the stored SIB1 is valid for the first network device 110 at 340. In some embodiments, the terminal device 130 may determine whether the stored SIB1 is valid based on the first information related to the first value tag and the second information related to the second value tag.

In some examples, if the first information related to the first value tag and the second information related to the second value tag meet a criterion, the terminal device 130 may determine that the stored SIB1 associated with the first network device 110 is valid. Otherwise, if the first information related to the first value tag and the second information related to the second value tag do not meet the criterion, the terminal device 130 may determine that the stored SIB1 associated with the first network device 110 is not valid. For example, the criterion may include that the second value tag being identical to the first value tag. For example, the criterion may include that a subset of the second value tag being identical to a subset of the first value tag.

In some examples, the first value tag includes a plurality of bits with a first number, e.g., N1 bits, and the second value tag includes a plurality of bits with a second number, e.g., N2 bits. For example, the N1 bits and the N2 bits may be the same with N2=N1, or the N2 bits may be part of the N1 bits with N2<N1. For example, part of N1 bits are the same as part of N2 bits, with N1=N2 or N1≠N2.

In some embodiments, as illustrated at step 440 in FIG. 4, the terminal device 130 may determine whether an access information part of the stored SIB1 is valid based on the first part of the first value tag and the first part of the second value tag. The terminal device 130 may determine whether a camping information part of the stored SIB1 is valid based on the second part of the first value tag and the second part of the second value tag.

In some examples, if the first part of the first value tag and the first part of the second value tag meet a first criterion, the terminal device 130 determines that the access information part of the stored SIB1 is valid. Otherwise, if the first part of the first value tag and the first part of the second value tag do not meet the first criterion, the terminal device 130 determines that the access information part of the stored SIB1 is not valid. For example, the first criterion may include that the first part of the second value tag being identical to the first part of the first value tag. For example, the first criterion may include that a subset of the first part of the second value tag being identical to a subset of the first part of the first value tag.

In some examples, if the second part of the first value tag and the second part of the second value tag meet a second criterion, the terminal device 130 determines that the camping information part of the stored SIB1 is valid. Otherwise, if the second part of the first value tag and the second part of the second value tag do not meet a second criterion, the terminal device 130 determines that the camping information part of the stored SIB1 is not valid. For example, the second criterion may include that the second part of the second value tag being identical to the second part of the first value tag. For example, the second criterion may include that a subset of the second part of the second value tag being identical to a subset of the second part of the first value tag.

In the process flow 300, the terminal device 130 determines that a SIB1 acquisition procedure is not required for the first network device 110 at 350, if the stored SIB1 is valid.

The terminal device 130 uses the stored SIB1 of first network device 110 if the stored SIB1 is valid for the first network device 110. In some examples, the SIB1 acquisition procedure is not required and thus the power can be saved. For example, the stored SIB1 may be used for acquiring additional SIBs of the first network device 110.

In some embodiments, the first network device 110 may provide a NES cell. In case the terminal device 130 has acquired SIB1 of the NES cell from an earlier access to the NES cell and the terminal device 130 returns to the same NES cell later on, the stored SIB1 can be reused if it is valid, thereby avoiding triggering the SIB1 acquisition procedure (e.g., acquiring WUS configuration, or transmitting WUS) for every access to the cell. Therefore, network energy saving can be achieved and the communication efficiency can be improved.

In some embodiments, the first network device 110 may provide a NES cell. In case the terminal device 130 has acquired SIB1 of the NES cell in which it is camping, and the previously acquired SIB1 is still valid for 3 hours, then the stored SIB1 can be reused. In case the stored SIB1 is still valid, there is no need for triggering WUS to request a new SIB1 even though the 3-hours validity expiration is passed.

In some embodiments, the terminal device 130 determines that a SIB1 acquisition procedure for the access information part of SIB1 is not required, if the access information part of the stored SIB1 is valid. In some embodiments, the terminal device 130 determines that a SIB1 acquisition procedure for the camping information part of SIB1 is not required, if the camping information part of the stored SIB1 is valid.

In some implementations, the terminal device 130 may determine that the SIB1 acquisition procedure is required if the stored SIB1 is not valid for the first network device 110. For example, although the terminal device 130 has a stored SIB1 associated with the first network device 110, the first information related to the first value tag and the second information related to the second value does not meet the criterion, in this case, the stored SIB1 is not valid. In some examples, if the stored SIB1 is not valid, the terminal device 130 may determine that a SIB1 acquisition procedure is required.

In some embodiments, if the first network device 110 is operating in an OD-SIB1 mode and the stored SIB1 is not valid, the terminal device 130 may determine whether a stored WUS configuration associated with the first network device 110 is valid. In some examples, if the stored WUS configuration associated with the first network device 110 is valid, the terminal device 130 may perform the SIB1 acquisition procedure based on the stored WUS configuration. In some examples, if the stored WUS configuration is not valid, the terminal device 130 may acquire a WUS configuration associated with the first network device 110, and then trigger an on-demand SIB1 acquisition procedure based on the acquired WUS configuration. For example, the WUS configuration may be acquired from the first network device 110 or the second network device 120, details of which may refer to the step 212, 222, or 231 in FIGS. 2A-2C respectively. For example, the terminal device 130 may transmit an OD-SIB1 request for the triggered on-demand SIB1 acquisition procedure, details of which may refer to the step 214, 224, or 233 in FIGS. 2A-2C respectively.

In some embodiments, as illustrated at step 450 in FIG. 4, the terminal device 130 may determine that a SIB1 acquisition procedure for at least one of the access information part or the camping information part of SIB1 is required, if at least one of the access information part or the camping information part of the stored SIB1 is not valid.

In some embodiments, the terminal device 130 may determine that a SIB1 acquisition procedure for the access information part of SIB1 is required, if the access information part of the stored SIB1 is not valid. For example, the terminal device 130 may perform the SIB1 acquisition procedure for the access information part of SIB1.

In some embodiments, the terminal device 130 determines that a SIB1 acquisition procedure for the camping information part of SIB1 is required, if the camping information part of the stored SIB1 is not valid. For example, the terminal device 130 may perform the SIB1 acquisition procedure for the camping information part of SIB1.

In some embodiments, if the first network device 110 is operating in an OD-SIB1 mode and the access information part (or the camping information part) of the stored SIB1 is not valid, the terminal device 130 may determine whether a stored WUS configuration associated with the first network device 110 is valid. In some examples, the WUS configuration may be dedicated to the access information part (or the camping information part) of SIB1. In some examples, the WUS configuration may be shared or common for the access information part and the camping information part of SIB1.

In some examples, if the stored WUS configuration associated with the first network device 110 is valid, the terminal device 130 may perform the SIB1 acquisition procedure for the access information part (or the camping information part) of SIB1 based on the stored WUS configuration. In some examples, if the stored WUS configuration is not valid, the terminal device 130 may acquire a WUS configuration associated with the first network device 110, and then trigger an on-demand SIB1 acquisition procedure for the access information part (or the camping information part) of SIB1 based on the acquired WUS configuration. For example, the WUS configuration may be acquired from the first network device 110 or the second network device 120, details of which may refer to the step 212, 222, or 231 in FIGS. 2A-2C respectively. For example, the terminal device 130 may transmit an OD-SIB1 request for the access information part (or the camping information part) of SIB1 based on the WUS configuration, details of which may refer to the step 214, 224, or 233 in FIGS. 2A-2C respectively. In some examples, the acquisition of the access information part (or the camping information part) of SIB1 does not require an on-demand procedure and can be based on a broadcast mode, i.e., the information is transmitted by the network according to a certain scheduling, which can be for instance indicated in the MIB or in specifications.

According to embodiments discussed above, the SIB1 acquisition procedure may be not required if the stored SIB1 is valid for the first network device 110, and thus the signaling overhead can be saved.

As mentioned above, the terminal device 130 may receive MIB or PBCH from the first network device 110, e.g., upon returning to the first network device 110. In some examples, the MIB or PBCH may further include a modification indication indicating that at least part of the system information has been modified. In some examples, the terminal device 130 may transmit a request for the at least part of the system information that has been modified, e.g., based on the modification indication. For example, the request may be transmitted to the first network device 110. Accordingly, the first network device 110 may provide, to the terminal device 130, the at least part of the system information that has been modified, e.g., based on the request.

In some examples, the MIB or PBCH may further include an indication indicating that a modification of the system information is not advertised in a paging indication (i.e., via paging). For example, a “no SI-modification used” indication may be included in the MIB. In some examples, the “no SI-modification used” indication may indicate that only certain SI modifications are not explicitly signalling, for example, the certain SI modifications may be related to certain SIBs only, such as related to UL configuration only.

In some examples, the minimum system information related to mobile-originated (MO) access to the network can be provided in a dedicated SIB1 part, referred here to as SIB1-UL, which may include PRACH configuration that can be used only for MO-access, Small Data Transmission Configuration, Access Class/category related parameters, etc. It can be up to the UE to ensure it has a valid SIB1-UL information before initiating an MO-access to the network. In some examples, a NW-based SI modification can be used for SIB1-DL information, containing information related to mobile-terminated (MT) access such as paging configuration, PRACH configuration to respond to paging, etc.

In some examples, SIBs associated to dedicated device types such as RedCap, NTN can operate without NW-advertised SI-modification.

Which SIBs are operated with or without NW-advertised SI-modification can be predefined or be specified in SIB1/mini-SIB1.

As mentioned above, in some examples, the first value tag may include a first part of the first value tag (related to an access information part of the stored SIB1) and a second part of the first value tag (related to a camping information part of the stored SIB1), it should be noted that the terms may be replaced by other names in some other embodiments. For example, the first part of the first value tag may be referred to as a first sub tag or a Value tag 1, and the second part of the first value tag may be referred to as a second sub tag or Value tag 2. For example, the stored SIB1 may include information related to Value tag 1 and information related to Value tag 2, where Value tag 1 is related to an access information part of the stored SIB1 and Value tag 2 is related to a camping information part of the stored SIB1.

As mentioned above, in some examples, the second value tag may include a first part of the second value tag (related to an access information part of SIB1) and a second part of the second value tag (related to a camping information part of SIB1), it should be noted that the terms may be replaced by other names in some other embodiments. For example, the first part of the second value tag may be referred to as a third sub tag or a Value tag 3, and the second part of the second value tag may be referred to as a fourth sub tag or Value tag 4. For example, Value tag 3 is related to an access information part of SIB1 and Value tag 4 is related to a camping information part of SIB1. In some examples, the terminal device 130 may acquire the access information part of SIB1 based on Value tag 3, and acquire the camping information part of SIB1 based on Value tag 4.

For example, the IE “SIB1” may be defined as the following:

| | |
|---|---|
| SIB1 ::= | CHOICE { |
| fullContent | SIB1-IEs, |
| changedContent | SIB1-ValueTags, |

...
}

| | |
|---|---|
| SIB1-IEs ::= | SEQUENCE { |

-- 5G-like SIB1 content comes here

| | | |
|---|---|---|
| lateNonCriticalExtension | OCTECT STRING | OPTIONAL, |
| nonCriticalExtension | SEQUENCE | OPTIONAL |

}

| | |
|---|---|
| SIB1-ValueTags ::= | SEQUENCE { |

-- ValueTag information for each SIB:

| sib-Changes | SIB-Mapping | |
|---|---|---|
| lateNonCriticalExtension | OCTET STRING | OPTIONAL, |
| nonCriticalExtension | SEQUENCE | OPTIONAL |

}

| SIB-Mapping ::= | SEQUENCE (SIZE (1..maxSIB)) OF SIB-Info | |
|---|---|---|
| SIB-Info ::= | SEQUENCE { | |
| sibNumber | INTEGER (0..64), | |
| valueTag | INTEGER (0..31) | OPTIONAL |

}

It should be noted that some examples are provided that the first value tag includes two parts related to access information part and camping information part of stored SIB1 respectively, the person in the skilled art may understand that the first value tag may be split in some other examples. For instance, the first value tag may be split into two parts related to MO-access SIB and MT-access SIB. For instance, the first value tag may be split into multiple parts related to SIB for different service types.

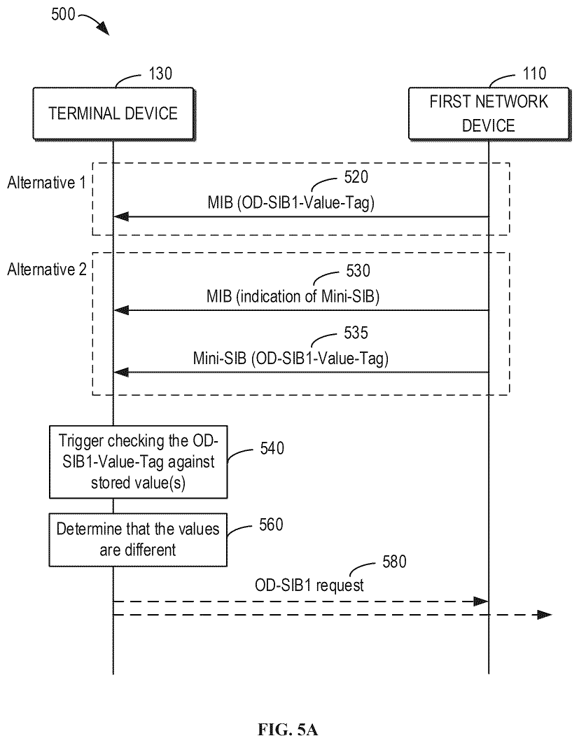

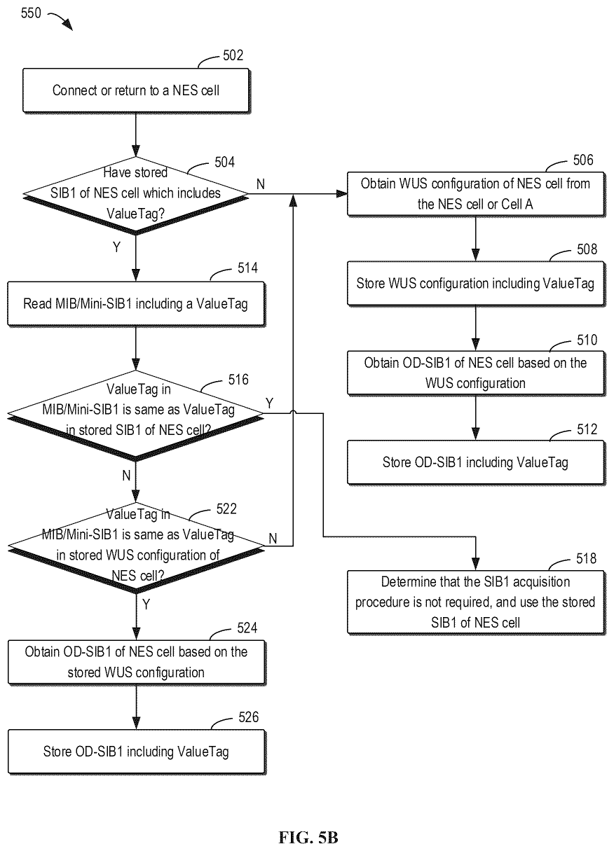

For providing more details of the present disclosure, a solution for checking a validity of OD-SIB1 associated with the first network device 110 is discussed below with reference to FIGS. 5A-5B.

FIG. 5A illustrates an example of a process flow 500 in accordance with some example embodiments of the present disclosure. The process flow 500 involves the first network device 110 and the terminal device 130. It is assumed that the terminal device 130 has a stored SIB1 associated with the first network device 110, and the stored SIB1 included first information related to a first value tag.

When the terminal device 130 returns to the first network device 110, an alternative 1 or alternative 2 may be performed.

In alternative 1, the first network device 110 transmits, and the terminal device 130 receives, the MIB including second information related to a second value tag at 520. For instance, the MIB includes OD-SIB1-Value-Tag.

In alternative 2, the first network device 110 transmits, and the terminal device 130 receives, the MIB including an indication of mini-SIB at 530, in addition, the first network device 110 transmits, and the terminal device 130 receives, the mini-SIB including second information related to a second value tag at 535. For example, the mini-SIB includes OD-SIB1-Value-Tag.

In some examples, an indication of the mini-SIB that included in the MIB may be represented as an information element (IE) “SIB1-Info”. For example, content in the MIB may be represented by:

| MIB | ::= SEQUENCE { |
|---|---|
| ... | |
| sib1-Info | SIB1-Info |

}

And the IE “SIB1-Info” may be defined as:

| | |
|---|---|
| SIB1-Info | :: = CHOICE { |
| sib1-scheduling | SIB1-Scheduling, |
| valueTag-SIB1 | ValueTag-SIB1 |

}

At 540, the terminal device 130 triggers checking the received second value tag (e.g., OD-SIB1-Value-Tag) against a stored value tag. For example, the terminal device 130 may check the validity of the stored SIB1 based on the first information related to the first value tag and the second information related to the second value tag. For example, the second value tag and the first value tag may be compared.

In the process flow 500, it is assumed that the terminal device 130 determines that the stored SIB1 is not valid. For example, the terminal device 130 determine that the first value tag and the second value tag are different at 560, thereby determining that the stored SIB1 is not valid. It should be noted that the illustrated step 560 is only one example for in-validity in the present disclosure, some other examples that not meeting the criterion are also applied, and the present disclosure does not limit for this aspect.

In addition, the terminal device 130 may trigger a SIB1 acquisition procedure, e.g., by transmitting a SIB1 request (e.g., represented as OD-SIB1 request) at 580. For example, the request may be transmitted to the first network device 110 in option 1 of non-standalone mode (FIG. 1A) or standalone mode (FIG. 1C). For example, the request may be transmitted to the second network device 120 in option 2 of non-standalone mode (FIG. 1). For example, the request may be transmitted based on a stored WUS configuration which is valid. It should be noted that a validity of the stored WUS configuration may be checked by the terminal device 130, details of which will not be provided her for brevity.

FIG. 5B illustrates an example process 550 for checking a validity of stored OD-SIB1 in accordance with some example embodiments of the present disclosure. The process 550 may be performed by the terminal device 130.

The terminal device 130 may connect or return to a NES cell at 502, for example, the NES cell may be provided by the first network device 110 which is operating in an on-demand SIB1 mode. The terminal device 130 may determine whether it has a stored SIB1 associated with the NES cell at 504, for example, the stored SIB1 includes first information related to a first value tag. If there is no stored SIB1 associated with the NES cell, the terminal device 130 further performs the step 506.

The terminal device 130 obtains a WUS configuration of the NES cell from the NES cell or form Cell A at 506. In addition, the obtained WUS configuration which includes a value tag can be stored at 508. The terminal device 130 may further obtain the OD-SIB1 associated with the NES cell based on the WUS configuration at 510. In addition, the obtained OD-SIB1 which includes a value tag can be stored at 510.

If the terminal device 130 has a stored SIB1 associated with the NES cell at 504, the terminal device 130 may further perform the step 514.

The terminal device 130 reads MIB or mini-SIB1 which includes second information related to a second value tag at 514, and further determine whether the second value tag is identical to the first value tag at 516.

If the second value tag is the same as the first value tag, the terminal device 130 may determine that the stored SIB1 is valid and further use the stored SIB1 at 518.

If the second value tag is different from the first value tag, the terminal device 130 may determine that the stored SIB1 is not valid. In addition, the terminal device 130 may further determine whether a stored WUS configuration is valid at 522, e.g., by comparing the second value tag and a value tag that included in the stored WUS configuration. If the stored WUS configuration is not valid, the terminal device 130 may perform the step 506. If the stored WUS configuration is valid, the terminal device 130 may obtain OD-SIB1 associated with the NES cell based on the stored WUS configuration at 524, and accordingly the acquired OD-SIB1 may be stored at 526.

It is to be noted that FIG. 5B illustrates a brief flow that performed by the terminal device 130 for checking a validity of OD-SIB1 associated with a NES cell, details related to the flow may refer to those provided above with reference to FIGS. 2A-5A, and will not be repeated herein.

It should be noted that although sub tags are used in some embodiments above, the terms are used only for illustration without any limitation. For example, the term “sub tag” may be replaced by a value tag or a tag or the like.

According to embodiments in the present disclosure, the SIB1 acquisition procedure may be not required if the stored SIB1 is valid for the first network device 110, and thus the signaling overhead can be saved.

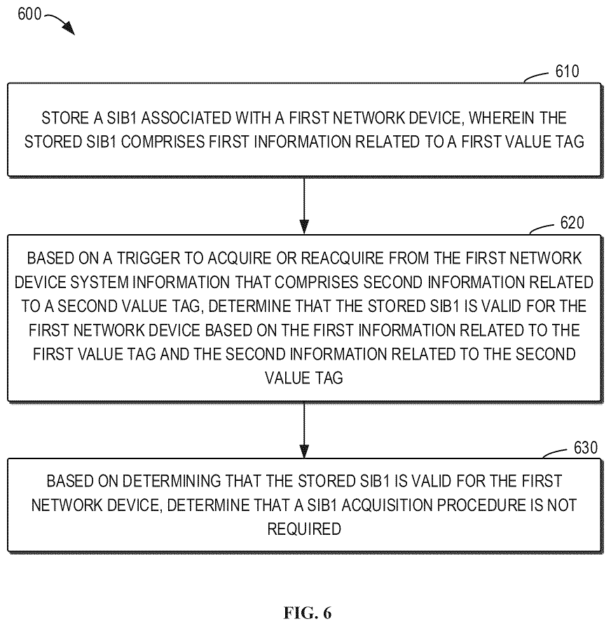

FIG. 6 illustrates a flowchart of a method 600 implemented at a terminal device in accordance with some example embodiments of the present disclosure. For the purpose of discussion, the method 600 will be described from the perspective of a terminal device 130 in FIG. 1D.

At block 610, the terminal device 130 stores a SIB1 associated with a first network device, wherein the stored SIB1 comprises first information related to a first value tag. At block 620, based on a trigger to acquire or reacquire from the first network device system information that comprises second information related to a second value tag, the terminal device 130 determines that the stored SIB1 is valid for the first network device based on the first information related to the first value tag and the second information related to the second value tag. At block 630, based on determining that the stored SIB1 is valid for the first network device, the terminal device 130 determines that a SIB1 acquisition procedure is not required.

In some example embodiments, the system information is a MIB or a PBCH.

In some example embodiments, the trigger to acquire or reacquire the system information comprises at least one of: connecting or reconnecting to the first network device, selecting or reselecting the first network device, or returning to the first network device.

In some example embodiments, the terminal device 130 receives, from the first network device, a MIB or a PBCH comprising an indication of the system information. In some example embodiments, the trigger to acquire or reacquire the system information comprises the indication in the MIB or PBCH. In some examples, the system information comprises part of information that is included in SIB1, for example, the system information only include the second information related to the second value tag.

In some example embodiments, the system information comprises the second information related to the second value tag, for checking whether the stored SIB1 is valid.

In some example embodiments, the MIB comprises a modification indication indicating that at least part of the system information has been modified.

In some example embodiments, the terminal device 130 transmits, to the first network device, a request for the at least part of the system information.

In some example embodiments, the MIB comprises an indication indicating that a modification of the system information is not advertised in a paging indication.

In some example embodiments, based on determining that the first value tag and the second value tag meet a criterion, the terminal device 130 determines that the stored SIB1 associated with the first network device is valid.

In some example embodiments, the criterion comprises at least one of: the second value tag is identical to the first value tag, or a subset of the second value tag is identical to a subset of the first value tag.

In some example embodiments, the SIB1 associated with the first network device is stored upon the terminal device selects or reselects or hands over to a different network device from the first network device.

In some example embodiments, based on determining that the stored SIB1 is not valid, the terminal device 130 determines that the SIB1 acquisition procedure is required.

In some example embodiments, based on determining that the first network device is operating in an on-demand SIB1 mode and the stored SIB1 is not valid, the terminal device 130 determines whether a stored WUS configuration associated with the first network device is valid. In some example embodiments, based on determining that the stored WUS configuration is valid, the terminal device 130 performs a SIB1 acquisition procedure based on the stored WUS configuration.

In some example embodiments, based on determining that the stored WUS configuration is not valid, the terminal device 130 acquires a WUS configuration associated with the first network device; and the terminal device 130 triggers an on-demand SIB1 acquisition procedure.

In some example embodiments, the WUS configuration associated with the first network device is acquired from the first network device or from a second network device.

In some example embodiments, the terminal device 130 transmits, to the first network device or the second network device, a SIB1 request based on the WUS configuration.

In some example embodiments, the second network device is an anchor for the first network device.

In some example embodiments, a first part of the first value tag is related to an access information part of the stored SIB1 and a second part of the first value tag is related to a camping information part of the stored SIB1.

In some example embodiments, the first value tag is related to an access information part of the stored SIB1, and wherein the stored SIB1 further comprises a third value tag which is related to a camping information part of the stored SIB1.

In some example embodiments, the terminal device 130 acquires at least one of the access related information or the camping related information based on corresponding value tag.

In some example embodiments, the first network device is associated with a NES cell.

In some example embodiments, the first value tag indicates a version of the stored SIB1.

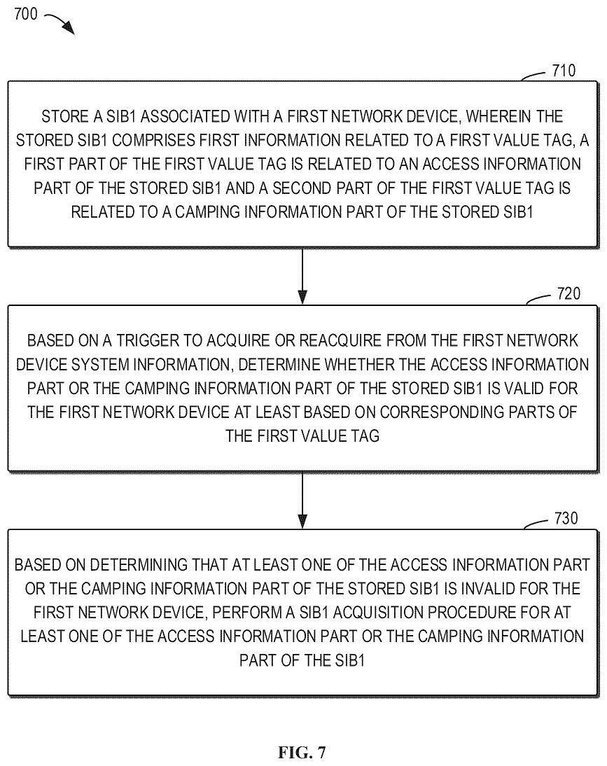

FIG. 7 illustrates a flowchart of a method 700 implemented at a terminal device in accordance with some example embodiments of the present disclosure. For the purpose of discussion, the method 700 will be described from the perspective of a terminal device 130 in FIG. 1D.

At block 710, the terminal device 130 stores a SIB1 associated with a first network device, wherein the stored SIB1 comprises first information related to a first value tag, a first part of the first value tag is related to an access information part of the stored SIB1 and a second part of the first value tag is related to a camping information part of the stored SIB1. At block 720, based on a trigger to acquire or reacquire from the first network device system information, the terminal device 130 determines whether the access information part or the camping information part of the stored SIB1 is valid for the first network device at least based on corresponding parts of the first value tag. At block 730, based on determining that at least one of the access information part or the camping information part of the stored SIB1 is invalid for the first network device, the terminal device 130 performs a SIB1 acquisition procedure for at least one of the access information part or the camping information part of the SIB1.

In some example embodiments, the terminal device 130 receives, from the first network device, system information comprising second information related to a second value tag, and wherein the second value tag is used for determining whether at least one of the access information part or the camping information part of the stored SIB1 is valid for the first network device.

In some example embodiments, the terminal device 130 determines whether the access information part of the stored SIB1 is valid based on the first part of the first value tag and a first part of the second value tag; and determines whether the camping information part of the stored SIB1 is valid based on the second part of the first value tag and a second part of the second value tag.

In some example embodiments, based on determining that the first part of the first value tag and the first part of the second value tag meet a criterion, the terminal device 130 determines that the access information part of the stored SIB1 is valid. In some example embodiments, based on determining that the second part of the first value tag and the second part of the second value tag meet the criterion, the terminal device 130 determines that the camping information part of the stored SIB1 is valid.

In some example embodiments, the criterion comprises at least one of: the first or second part of the second value tag is identical to a corresponding part of the first value tag, or a subset of the first or second part of the second value tag is identical to a subset of the corresponding part of the first value tag.

In some example embodiments, the trigger to acquire or reacquire the system information comprises at least one of: connecting or reconnecting to the first network device, selecting or reselecting the first network device, or returning to the first network device.

In some example embodiments, based on determining that the access information part of the stored SIB1 is valid for the first network device, the terminal device 130 determines that a SIB1 acquisition procedure for the access information part of the SIB1 is not required.

In some example embodiments, based on determining that the camping information part of the stored SIB1 is valid for the first network device, the terminal device 130 determines that a SIB1 acquisition procedure for the camping information part of the SIB1 is not required.

In some example embodiments, based on determining that the access information part or the camping information part of the stored SIB1 is invalid, the terminal device 130 determines whether a stored WUS configuration associated with the first network device is valid. In some example embodiments, based on determining that the stored WUS configuration is valid, the terminal device 130 performs the SIB1 acquisition procedure for the access information part or the camping information part of the SIB1 based on the stored WUS configuration.

In some example embodiments, based on determining that the stored WUS configuration is not valid, the terminal device 130 acquires a WUS configuration associated with the first network device; and performs an on-demand SIB1 procedure for the access information part or the camping information part of the SIB1 based on the stored WUS configuration.

In some example embodiments, the WUS configuration associated with the first network device is acquired from the first network device or from a second network device.

In some example embodiments, the terminal device 130 transmits, to the first network device or the second network device, a SIB1 request for at least one of the access information part or the camping information part of the SIB1 based on the WUS configuration.

In some example embodiments, the second network device is an anchor for the first network device.

In some example embodiments, the WUS configuration is dedicated to at least one of the access information part or the camping information part of the SIB1.

In some example embodiments, the system information is a MIB or a PBCH.

In some example embodiments, the terminal device 130 receives, from the first network device, an MIB or a PBCH comprising an indication of the system information. In some example embodiments, the system information is received based on the indication in the MIB or PBCH.

In some example embodiments, the MIB comprises a modification indication indicating that at least part of the system information has been modified.

In some example embodiments, the terminal device 130 transmits, to the first network device, a request for the at least part of the system information.

In some example embodiments, the MIB comprises an indication indicating that a modification of the system information is not advertised.

In some example embodiments, the SIB1 associated with the first network device is stored upon the terminal device selects or reselects or hands over to a different network device from the first network device.

In some example embodiments, the first network device is associated with a NES cell.

In some example embodiments, the first value tag indicates a version of the stored SIB1.

In some example embodiments, the first part and second part of the first value tag are two different sub tags.

In some example embodiments, an apparatus capable of performing the method 600 (for example, the terminal device 130) may comprise means for performing the respective steps of the method 600. The means may be implemented in any suitable form. For example, the means may be implemented in a circuitry or software module.

In some example embodiments, the apparatus comprises: means for storing a SIB1 associated with a first network device, wherein the stored SIB1 comprises first information related to a first value tag; means for based on a trigger to acquire or reacquire from the first network device system information that comprises second information related to a second value tag, determining that the stored SIB1 is valid for the first network device based on the first information related to the first value tag and the second information related to the second value tag; and means for based on determining that the stored SIB1 is valid for the first network device, determining that a SIB1 acquisition procedure is not required.

In some example embodiments, an apparatus capable of performing the method 700 (for example, the terminal device 130) may comprise means for performing the respective steps of the method 700. The means may be implemented in any suitable form. For example, the means may be implemented in a circuitry or software module.

In some example embodiments, the apparatus comprises: means for storing a SIB1 associated with a first network device, wherein the stored SIB1 comprises first information related to a first value tag, a first part of the first value tag is related to an access information part of the stored SIB1 and a second part of the first value tag is related to a camping information part of the stored SIB1; means for based on a trigger to acquire or reacquire from the first network device system information, determining whether the access information part or the camping information part of the stored SIB1 is valid for the first network device at least based on corresponding parts of the first value tag; and means for based on determining that at least one of the access information part or the camping information part of the stored SIB1 is invalid for the first network device, performing a SIB1 acquisition procedure for at least one of the access information part or the camping information part of the SIB1.

The term “means” as used in the description and in the claims may refer to one or more individual elements configured to perform the corresponding recited functionality or functionalities, or it may refer to several elements that perform such functionality or functionalities. Furthermore, several functionalities recited in the claims may be performed by the same individual means or the same combination of means. For example, performing such functionality or functionalities may be caused in an apparatus by a processor that executes instructions stored in a memory of the apparatus.

FIG. 8 illustrates a simplified block diagram of a device 800 that is suitable for implementing some example embodiments of the present disclosure. The device 800 may be provided to implement the terminal device discussed above, for example the terminal device 130 in FIG. 1D. As shown, the device 800 includes one or more processors 810, one or more memories 820 coupled to the processor 810, and one or more communication modules 840 coupled to the processor 810.

The communication module 840 is for bidirectional communications. The communication module 840 has at least one antenna to facilitate communication. The communication interface may represent any interface that is necessary for communication with other network elements.

The processor 810 may be of any type suitable to the local technical network and may include one or more of the following: general purpose computers, special purpose computers, microprocessors, digital signal processors (DSPs) and processors based on multicore processor architecture, as non-limiting examples. The device 800 may have multiple processors, such as an application specific integrated circuit chip that is slaved in time to a clock which synchronizes the main processor.

The memory 820 may include one or more non-volatile memories and one or more volatile memories. Examples of the non-volatile memories include, but are not limited to, a Read Only Memory (ROM) 824, an electrically programmable read only memory (EPROM), a flash memory, a hard disk, a compact disc (CD), a digital video disk (DVD), and other magnetic storage and/or optical storage. Examples of the volatile memories include, but are not limited to, a random access memory (RAM) 822 and other volatile memories that will not last in the power-down duration.

A computer program 830 includes computer executable instructions that are executed by the associated processor 810. The program 830 may be stored in the ROM 824. The processor 810 may perform any suitable actions and processing by loading the program 830 into the RAM 822.

The embodiments of the present disclosure may be implemented by means of the program 830 so that the device 800 may perform any process of the disclosure as discussed with reference to FIGS. 2A-7. The embodiments of the present disclosure may also be implemented by hardware or by a combination of software and hardware.

In some example embodiments, the program 830 may be tangibly contained in a computer readable medium which may be included in the device 800 (such as in the memory 820) or other storage devices that are accessible by the device 800. The device 800 may load the program 830 from the computer readable medium to the RAM 822 for execution. The computer readable medium may include any types of tangible non-volatile storage, such as ROM, EPROM, a flash memory, a hard disk, CD, DVD, and the like.

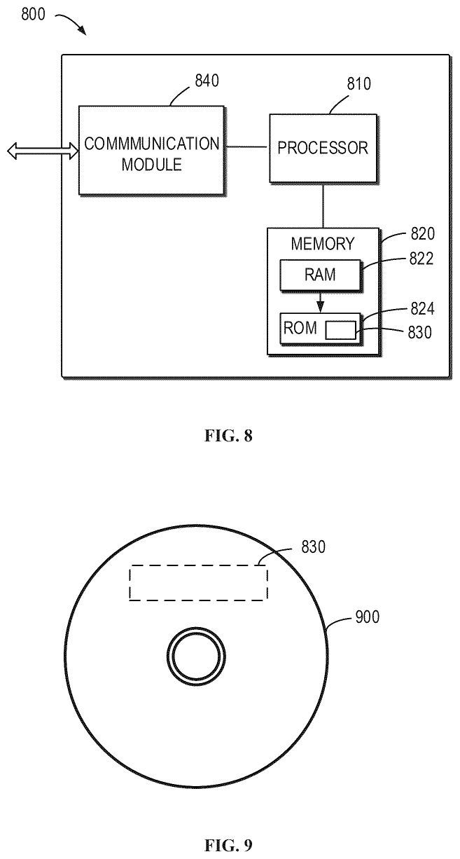

FIG. 9 illustrates a block diagram of an example of a computer readable medium 900 in accordance with some example embodiments of the present disclosure. The computer readable medium 900 has the program 830 stored thereon. It is noted that although the computer readable medium 900 is depicted in form of CD or DVD in FIG. 9, the computer readable medium 900 may be in any other form suitable to carry or hold the program 830.

Various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the method as described above with reference to any of FIGS. 2A-7. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for the methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be performed. The program code may execute entirely on a machine, partly on the machine, as a stand-alone software package, partly on the machine and partly on a remote machine or entirely on the remote machine or server.

In the context of the present disclosure, the computer program codes or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. The term “non-transitory,” as used herein, is a limitation of the medium itself (i.e., tangible, not a signal) as opposed to a limitation on data storage persistency (e.g., RAM vs. ROM).

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1. A terminal device comprising:
at least one processor; and
at least one memory storing instructions that, when executed by the at least one processor, cause the terminal device at least to:
store a system information block 1 (SIB1) associated with a first network device, wherein the stored SIB1 comprises first information related to a first value tag;
based on a trigger to acquire or reacquire from the first network device system information that comprises second information related to a second value tag, determine that the stored SIB1 is valid for the first network device based on the first information related to the first value tag and the second information related to the second value tag; and
based on determining that the stored SIB1 is valid for the first network device, determine that a SIB1 acquisition procedure is not required.

2. The terminal device of claim 1, wherein the system information is a master information block (MIB) or a physical broadcast channel (PBCH).

3. The terminal device of claim 1, wherein the trigger to acquire or reacquire the system information comprises at least one of:
connecting or reconnecting to the first network device,
selecting or reselecting the first network device, or
returning to the first network device.

4. The terminal device of claim 1, wherein the at least one processor is further configured to cause the terminal device to:
receive, from the first network device, a MIB or a PBCH comprising an indication of the system information.

5. The terminal device of claim 4, wherein the system information comprises the second information related to the second value tag, for checking whether the stored SIB1 is valid.

6. The terminal device of claim 4, wherein the MIB comprises a modification indication indicating that at least part of the system information has been modified.

7. The terminal device of claim 6, wherein the at least one processor is further configured to cause the terminal device to:
transmit, to the first network device, a request for the at least part of the system information.

8. The terminal device of claim 4, wherein the MIB comprises an indication indicating that a modification of the system information is not advertised in a paging indication.

9. The terminal device of claim 1, wherein the at least one processor is configured to cause the terminal device to determine that the stored SIB1 is valid by:
based on determining that the first value tag and the second value tag meet a criterion, determining that the stored SIB1 associated with the first network device is valid.

10. The terminal device of claim 9, wherein the criterion comprises at least one of:
the second value tag is identical to the first value tag, or
a subset of the second value tag is identical to a subset of the first value tag.

11. The terminal device of claim 1, wherein the SIB1 associated with the first network device is stored upon the terminal device selects or reselects or hands over to a different network device from the first network device.

12. The terminal device of claim 1, wherein the at least one processor is further configured to cause the terminal device to:
based on determining that the stored SIB1 is not valid, determine that the SIB1 acquisition procedure is required.

13. The terminal device of claim 12, wherein the at least one processor is further configured to cause the terminal device to:
based on determining that the first network device is operating in an on-demand SIB1 mode and the stored SIB1 is not valid, determine whether a stored wake up signal (WUS) configuration associated with the first network device is valid; and
based on determining that the stored WUS configuration is valid, perform a SIB1 acquisition procedure based on the stored WUS configuration.

14. The terminal device of claim 13 wherein the at least one processor is further configured to cause the terminal device to:
based on determining that the stored WUS configuration is not valid, acquire a WUS configuration associated with the first network device; and
trigger an on-demand SIB1 acquisition procedure.

15. The terminal device of claim 14, wherein the WUS configuration associated with the first network device is acquired from the first network device or from a second network device.

16. The terminal device of claim 13, wherein the at least one processor is configured to cause the terminal device to perform the on-demand SIB1 procedure by:
transmit, to the first network device or the second network device, a SIB1 request based on the WUS configuration.

17. The terminal device of claim 15, wherein the second network device is an anchor for the first network device.

18. The terminal device of claim 1, wherein a first part of the first value tag is related to an access information part of the stored SIB1 and a second part of the first value tag is related to a camping information part of the stored SIB1.

19. The terminal device of claim 1, wherein the first value tag is related to an access information part of the stored SIB1, and wherein the stored SIB1 further comprises a third value tag which is related to a camping information part of the stored SIB1.

20-22. (canceled)

23. A communication method comprising:
storing a system information block 1 (SIB1) associated with a first network device, wherein the stored SIB1 comprises first information related to a first value tag;
based on a trigger to acquire or reacquire from the first network device system information that comprises second information related to a second value tag, determining that the stored SIB1 is valid for the first network device based on the first information related to the first value tag and the second information related to the second value tag; and
based on determining that the stored SIB1 is valid for the first network device, determining that a SIB1 acquisition procedure is not required.

24-25. (canceled)
